(19) United States
(12) Patent Application Publication
(10) Pub. No.: US 2015/0244192 A1
(43) Pub. Date: Aug. 27, 2015

(54) CIRCUIT FOR MANAGING THE CHARGE OF A BATTERY

(71) Applicant: COMMISSARIAT A L'ENERGIE ATOMIQUE ET AUX ENERGIES ALTERNATIVES, Paris (FR)

(72) Inventors: Julien Dauchy, Moirans (FR); Daniel Chatroux, Teche (FR)

(21) Appl. No.: 14/432,661

(22) PCT Filed: Oct. 4, 2013
(86) PCT No.: PCT/FR2013/052366

§ 371 Date: Mar. 31, 2015

(30) Foreign Application Priority Data
Oct. 4, 2012 (FR) 1259432

(51) Int. Cl. H02J 7/00

(52) U.S. Cl. CPC H02J 7/0021; H02J 7/007

(57) ABSTRACT

The instant disclosure describes a circuit for managing the charge of a battery, comprising a least one heating element configured to produce heat when the voltage at the terminals thereof exceeds a threshold.

### BACKGROUND

The present invention generally relates to electric batteries, and more particularly aims at the management of the charge in a battery. It particularly relates to a charge management circuit capable of implementing charge balancing and interruption functions in a battery of a plurality of elementary cells.

### DISCUSSION OF THE RELATED ART

An electric battery is a group of a plurality of elementary cells (accumulators, etc.) connected in series and/or in parallel between two nodes or terminals, respectively positive and negative, for outputting a D.C. voltage. During battery discharge phases, a current flows from the positive terminal to the negative terminal of the battery, through a load to be powered. During battery charge phases, a charger applies a charge current flowing through the negative terminal to the positive terminal of the battery. This current flows through the different cells of the battery, which causes the charge thereof. A battery is generally associated with a charge management circuit configured in order to, during recharge phases, detect the end of the charge and interrupt the charge soon enough to avoid an overcharge which might cause damage. The charge management circuit may further be capable of balancing the charge levels of the battery cells during recharge phases. In certain batteries, the charge management circuit is relatively complex, and significantly contributes to increasing the cost, the weight, and/or the bulk of the battery.

### SUMMARY

Thus, an object of an embodiment of the present invention is to provide a circuit for managing the charge of a battery of elementary cells, this circuit comprising: a plurality of heating elements, each heating element being capable of clamping the voltage thereacross by dissipating heat beyond an activation voltage, and the different heating elements being intended to be connected across different sub-assemblies of one or a plurality of cells of the battery; at least one temperature sensor capable of detecting an activation of one or a plurality of said heating elements; and a control circuit capable of controlling the charge current of the battery according to detections of activations of heating elements by the temperature sensor.

According to an embodiment, the activation voltage of each heating element is selected according to the nominal full charge voltage of the sub-assembly of cells to which it is intended to be connected.

According to an embodiment, the activation voltage of each heating element is greater than or equal to the nominal full charge voltage of the sub-assembly of cells to which it is intended to be connected.

According to an embodiment, the activation voltage of each heating element is smaller than the nominal full charge voltage of the sub-assembly of cells to which it is intended to be connected.

According to an embodiment, each heating element comprises a Zener diode.

According to an embodiment, each heating element comprises an integrated clamping circuit having a programmable activation voltage.

According to an embodiment, each sub-assembly comprises a single cell.

According to an embodiment, each sub-assembly comprises at least two cells.

According to an embodiment, the charge management circuit comprises a plurality of temperature sensors, the different temperature sensors being thermally coupled with different heating elements.

According to an embodiment, the control circuit is configured to modify the charge current when the activation of a heating element is detected.

According to an embodiment, the modification of the charge current comprises decreasing the charge current without totally interrupting it.

According to an embodiment, the modification of the charge current comprises interrupting the charge current.

According to an embodiment, the control circuit is configured to interrupt the charge current when each of the temperature sensors detects an activation of a heating element.

Another embodiment provides an assembly comprising a battery of elementary cells and a charge management circuit of the above-mentioned type.

### BRIEF DESCRIPTION OF THE DRAWINGS

The foregoing and other features and advantages will be discussed in detail in the following non-limiting description of specific embodiments in connection with the accompanying drawings, among which:

FIG. 1 is an electric diagram of an example of an assembly comprising a battery and an example of a circuit for managing the battery charge;

FIG. 2 is an electric diagram of an example of an assembly comprising a battery and another example of a circuit for managing the battery charge;

FIG. 3 is an electric diagram of an example of an assembly comprising a battery and an example of a circuit for managing the battery charge;

FIG. 4 is an electric diagram of an example of an assembly comprising a battery and an alternative embodiment of a circuit for managing the battery charge;

FIG. 5 is a partial electric diagram of the assembly of FIG. 3, illustrating in more detailed fashion an embodiment of an element of the charge management circuit of FIG. 3;

FIG. 6 is a partial electric diagram of the assembly of FIG. 4, illustrating in more detailed fashion an embodiment of an element of the charge management circuit of FIG. 4;

FIG. 7 is a timing diagram illustrating an example of operation of a charge management circuit of the type described in relation with FIGS. 3 to 6; and

FIG. 8 is an electric diagram of an example of an assembly comprising a battery and another alternative embodiment of a circuit for managing the battery charge.

For clarity, the same elements have been designated with the same reference numerals in the different drawings. Further, only those elements which are useful to the understanding of the described embodiments have been detailed.

### DETAILED DESCRIPTION

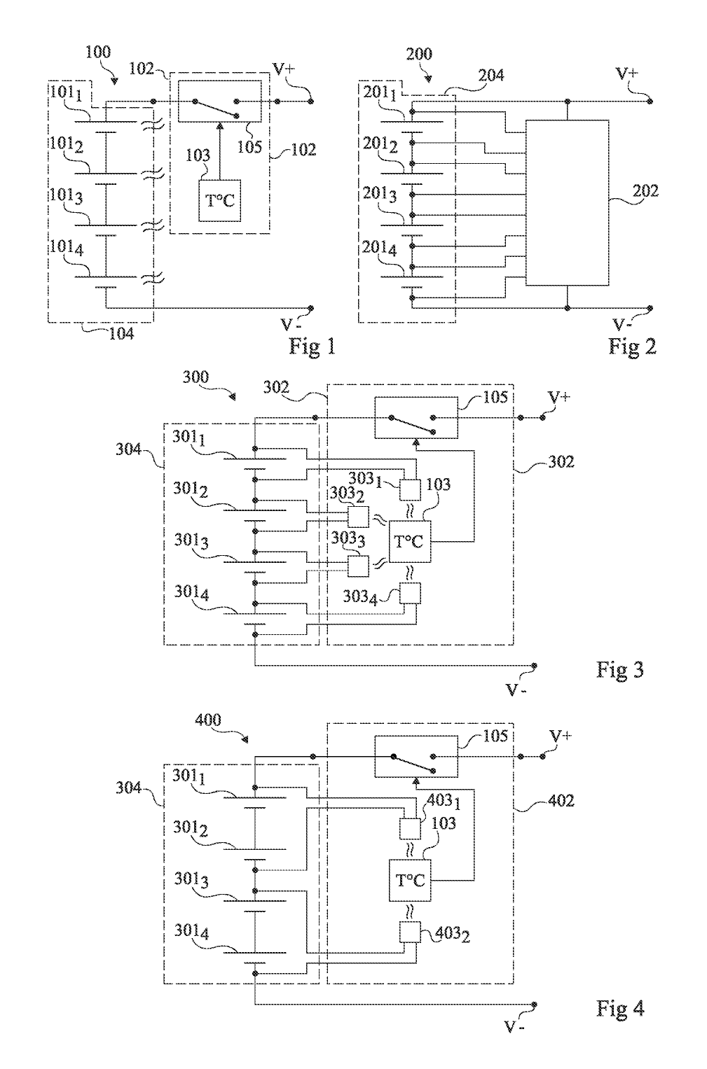

FIG. 1 is an electric diagram of an example of an assembly 100 comprising a battery 104 of four elementary cells 101ᵢ, i being an integer in the range from 1 to 4, series-connected between terminals V₊ and V₋ for outputting a D.C. voltage. In this example, cells 101ᵢ are nickel-cadmium (NiCd) or nickel-metal hydride (NiMH) cells. Such cells have the property that, when a charge current flows therethrough after they have reached their nominal full charge level, that is, after the voltage thereacross has reached a given voltage level, or nominal full charge level, they start heating under the effect of parasitic chemical reactions. A charged cell may, at least for some time, keep on being submitted to a charge current without being damaged. In this case, the voltage across this cell keeps on increasing beyond the nominal full charge voltage without causing damage to the cell. When the charge current is interrupted, the voltage across the cell then decreases back and stabilizes at the nominal full charge voltage of the cell. The excess electric power is dissipated in parasitic chemical reactions. The voltage across such cells should however not exceed a given critical threshold, or maximum voltage that the cell can withstand, otherwise the cell will be degraded.

Assembly 100 further comprises a charge management circuit 102 coupled to battery 104, configured to detect the end of the charge and interrupt the charge current before an overcharge capable of damaging the battery occurs. Circuit 102 comprises a temperature sensor 103 placed inside of the assembly, close to cells 101ᵢ, and a control circuit 105 configured to control the charge current according to the temperature measured by sensor 103. Towards the end of a charge phase, when the most charged cells exceed their nominal full charge level, sensor 103 detects a temperature rise within the assembly, due to parasitic chemical reactions in this cell. As an example, in a first phase, the charge current is not interrupted, and the less charged cells keep on charging. The battery is for example considered to be sufficiently charged when the temperature rise measured by sensor 103 within the assembly exceeds a threshold. This threshold for example corresponds to the activation of the parasitic chemical reactions in all the battery cells or in a significant number of cells of the battery. Circuit 105 then interrupts the charge current. Thus, charge management circuit 102 implements not only a battery charge interruption function, but also a battery cell balancing function.

Charge management circuit 102 of FIG. 1 has the advantage of being particularly simple to form, light, and of low bulk. Further, management circuits of this type being already provided in many existing nickel-cadmium batteries or nickel-metal hydride batteries, the development costs of this circuit are amortized and its cost is decreased.

However, circuit 102 is only compatible with cells where the end of charge results in a significant increase of the cell temperature. This is not true for all cells. In particular, this is not true for lithium-ion cells, where, at the end of the charge, the voltage across the cell keeps on increasing beyond the nominal full charge voltage of the cell without causing a heating, up to a critical level beyond which the cell risks being damaged. Specific charge management circuits more complex and more expensive than the circuit of FIG. 1 should then be provided.

FIG. 2 is an electric diagram of another example of an assembly 200 comprising a battery 204 of four elementary cells 201ᵢ, i being an integer in the range from 1 to 4, series-connected between D.C. voltage output terminals V₊ and V₋. In this example, cells 201ᵢ are cells where the end of charge does not cause a significant heating of the cell, for example, lithium-ion cells. Assembly 200 further comprises a charge management circuit 202 configured to detect the end of charge and interrupt the charge before an overcharge level capable of damaging the battery is reached. Circuit 202 has inputs connected to each of the battery cells. It is configured to monitor the voltage across each cell and interrupt the charge before a cell reaches its critical overcharge voltage level. Circuit 200 for example comprises differential measurement circuits, comparators, etc. Circuit 202 may further be configured to implement balancing functions, via bypass branches, if it detects disparities in the charge speed of the different cells.

Charge management circuits of the type described in relation with FIG. 2 may be formed whatever the cell technology used. Circuits of this type however have the disadvantage of being more complex, more bulky, and more expensive than management circuits of the type described in relation with FIG. 1.

FIG. 3 is an electric diagram of an example of an assembly 300 comprising a battery 304 and an embodiment of a charge management circuit 302. In this example, battery 304 comprises four elementary cells 301ᵢ, i being an integer from 1 to 4, series-connected between D.C. voltage output terminals V₊ and V₋. Cells 301ᵢ may be of any technology type. As an example, cells 301ᵢ are cells where, at the end of charge, if a charge current is applied after the cell has reached its nominal full charge level, the voltage across the cell rises above the nominal full charge level without for the cell to significantly heat up. Cells 301ᵢ are for example lithium-ion cells.

According to an aspect, charge management circuit 302 comprises, associated with each of cells 301ᵢ of the battery, a heating element 303ᵢ configured to generated heat when the voltage thereacross exceeds a voltage threshold, or activation voltage. The activation voltage of heating elements 303ᵢ is for example equal to the nominal full charge voltage of the battery cells. As a variation, if the cells can withstand, without being damaged, some overcharge beyond their nominal full charge voltage, the activation threshold may be between the nominal full charge voltage and the critical overcharge voltage of the cells, that is, the maximum voltage that a cell can withstand without being damaged. As a variation, if the cells can withstand no overcharge beyond their nominal full charge voltage, the activation threshold of the heating elements may be lower than the nominal full charge voltage of the cells, for example, in the range from 80 to 95% of between the nominal full charge voltage of the cells.

Circuit 302 further comprises a temperature sensor 103, placed inside of the assembly, and a control circuit 105 capable of controlling the charge current of the battery according to the temperature measured by sensor 103. Sensor 103 is for example a thermistor sensor having a negative temperature coefficient. Any other type of temperature sensor may however be used.

Towards the end of a battery charge phase, when the most charged cell(s) 301ᵢ reach the activation level of the heating elements 303ᵢ which are associated therewith, the corresponding heating element(s) 303ᵢ start generating heat, and sensor 103 detects a temperature rise within the assembly. It should be noted that circuit 302 may comprise additional means, not shown, enabling to differentiate a temperature rise due to the activation of one or a plurality of heating elements from a temperature rise due to other phenomena, for example, due to a rise of the ambient temperature. Such additional means for example comprise an ambient temperature sensor different from sensor 103, and/or means for analyzing the variation slopes of the temperature measured by sensor 103.

As an example, when sensor 103 detects a temperature rise due to the activation of one or a plurality of heating elements, the charge current may, in a first phase, be maintained. The less charged cells then keep on charging until the activation threshold of the heating elements associated therewith is reached. The battery may for example be considered as sufficiently charged when the temperature rise measured by sensor 103 within the assembly exceeds a threshold. This threshold for example corresponds to the activation of the heating elements of all the battery cells or of a significant number of cells. The charge current can thus be interrupted by control circuit 105. Thus, charge management circuit 302 implements not only a battery charge interruption function, but also a battery cell balancing function.

Charge management circuit 302 has the advantage of being particularly simple to form. As an example, to form temperature sensor 103 and the associated control circuit 105 of circuit 302, a charge management circuit of the type described in relation with FIG. 1, already existing in nickel-cadmium or metal nickel-hydride batteries, which may be used with no modification. It is then sufficient to connect a heating element 303ᵢ in parallel with each of the battery cells to obtain assembly 300 of FIG. 3. In other words, the provision of heating elements across the cells enables to artificially reproduce the heat generation phenomenon which naturally occurs at the end of charge in certain cell technologies (for example, NiCd or NiMH). This enables to reuse existing charge management circuits in technologies where the cells do not naturally (that is, by chemical reaction) generate heat at the end of charge.

Charge management circuit 302 is particularly well adapted to batteries using lithium-ion cells based on iron phosphate (LiFePO₄). Indeed, in this type of cell, there exists a relatively large voltage range between the nominal full charge voltage of the cell and the critical voltage of the cell, or maximum voltage that the cell can withstand without being damaged. This provides some flexibility in the selection of the activation threshold of the heating elements. Heating elements 303ᵢ having an activation threshold comprised within this range are preferably provided. As an example, A123 SYSTEMS commercializes lithium-ion cells based on iron phosphate having a 3.6-V nominal full charge voltage and capable of withstanding an overvoltage up to 4.2 V, or even 4.5 V (critical cell voltage), with no risk of being damaged. Such cells further have the advantage, when they are assembled in a battery and crossed by substantially identical currents, of charging in relatively balanced fashion (that is, substantially at the same speed). The inventors have observed that the described embodiments work particularly well with such cells.

In a preferred embodiment, as schematically illustrated in FIG. 3, elements 303ᵢ are located close to temperature sensor 103, to minimize the time taken by sensor 103 to detect the heating of elements 303ᵢ. To further improve the thermal coupling between elements 303ᵢ and sensor 103, thermal contact grease, the encapsulation of element 303ᵢ and of sensor 103 in the thermally-conductive resin, or any other adapted thermal coupling solution, may be used.

According to the envisaged use, and particularly to the type of cell used and to the capacity of the cells to withstand overcharges, various modes of control of the charge current by circuit 105 may be provided. As an example, in a first control mode, circuit 105 may be configured to interrupt the charge current as soon as the activation of one of elements 303ᵢ is detected. In a second embodiment, circuit 105 may be configured to decrease the charge current without interrupting it when the activation of one of elements 303ᵢ is detected, and then maintain the charge current at a decreased level for some time before totally interrupting it. In a third control mode, circuit 105 may be configured to decrease the charge current without interrupting it when the temperature rise detected by sensor 103 exceeds a first threshold, maintain a decreased charge current when the temperature rise detected by sensor 103 is between the first threshold and a second threshold greater than the first threshold, and interrupt the charge current when the temperature rise measured by sensor 103 is greater than the second threshold. Thus, circuit 302 has the advantage of enabling to at least partially balance the cell charge level, in the case where the cells would not all charge at the same speed.

FIG. 4 is an electric diagram illustrating an example of an assembly 400 comprising battery 304 of FIG. 3 and an alternative embodiment of a charge management circuit 402. Charge management circuit 402 comprises, as in the example of FIG. 3, a temperature sensor 103 placed inside of the assembly and a control circuit 105 connected to sensor 103 and capable of controlling the battery charge current according to the temperature measured by sensor 103.

Charge management circuit 402 of FIG. 4 differs from circuit 302 of FIG. 3 in that in the circuit of FIG. 4, a same heating element is associated with a plurality of cells 301ᵢ, instead of a single heating element per cell in the circuit of FIG. 3. In the shown example, circuit 402 comprises two heating elements 403ⱼ, j being an integer from 1 to 2. Heating element 403₁ is connected in parallel with the series association of cells 301₁ and 301₂, and heating element 403₂ is connected in parallel with the series association of cells 301₃ and 301₄. Each heating element 403ⱼ is configured to generate heat when the voltage thereacross exceeds an activation threshold or activation voltage, for example, equal to twice the nominal full charge voltage of a cell. As a variation, if the cells can withstand, without being damaged, some overcharge beyond their nominal full charge voltage, the activation threshold may be between twice the nominal full charge voltage and twice the critical overcharge voltage of a cell. As a variation, if the cells can withstand no overcharge beyond their nominal full charge voltage, the activation threshold of the heating elements may be lower than twice the nominal full charge voltage of the cells.

An advantage of the embodiment of FIG. 4 is that, for a given number of elementary cells in the battery, it requires less heating elements than the embodiment of FIG. 3. Further, in the embodiment of FIG. 4, the heating elements are activated to voltage levels higher than in the embodiment of FIG. 3, which makes them easier to form. The embodiment of FIG. 4 is particularly well adapted to batteries using cells naturally having a good balancing level, and where it can be considered that neighboring cells charge substantially at the same speed.

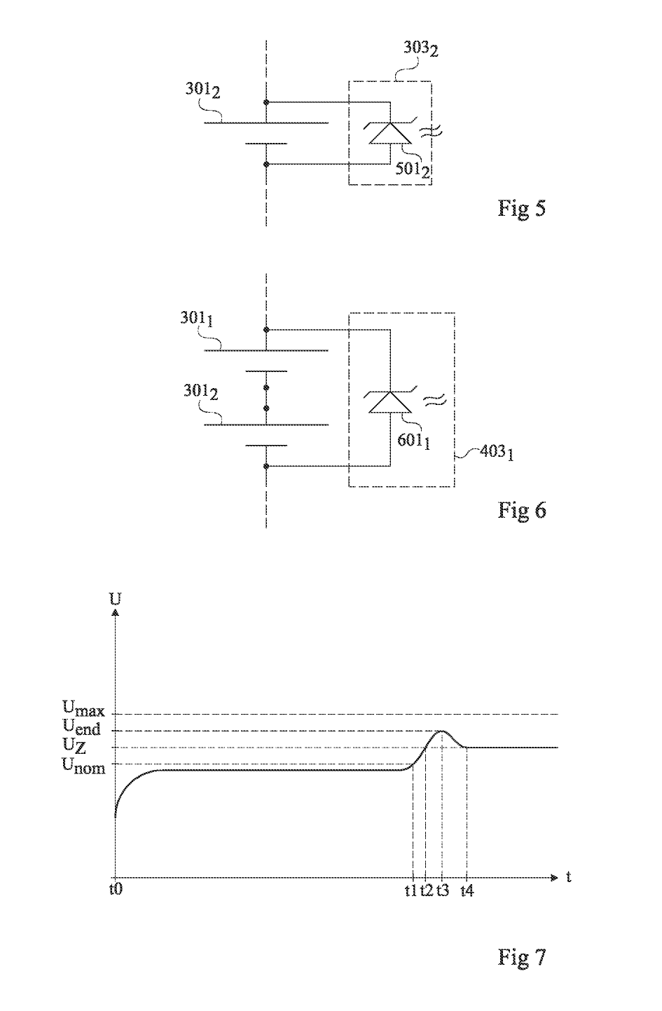

FIG. 5 is a partially electric diagram showing in more detailed fashion an embodiment of a heating element compatible with the described embodiments. In FIG. 5, only one elementary cell 301₂ and one heating element 303₂ connected across this cell have been shown. Heating element 303₂ comprises a Zener diode 501₂ having its anode and its cathode respectively connected to the low potential terminal and to the high potential terminal of cell 301₂. The breakdown voltage of the Zener diode determines the activation threshold of the heating element. When the voltage across the battery exceeds the breakdown voltage of the Zener diode, the overvoltage is clamped by the Zener diode and the excess electric power is dissipated in the form of heat by the Zener diode.

As a variation, Zener diode 501₂ may be replaced with a circuit carrying out the same functions of clamping and power dissipation in the form of heat as a Zener diode, but having a programmable turn-on threshold. As an example, the integrated circuit sold under reference TL431 enables to carry out the above-mentioned functions with a programmable activation threshold. When such a programmable circuit is used, heating element 303₂ may further comprise biasing resistors and/or a series resistor for protecting the programmable circuit.

The use of a programmable circuit is particularly advantageous in the case where the targeted activation threshold of the heating element is low, for example, lower than from 5 to 10 volts. Indeed, Zener diodes with a low breakdown voltage are relatively difficult to manufacture and may non-negligibly leak in the off state.

FIG. 6 shows an alternative embodiment of the diagram of FIG. 5, in the case where a same heating element is associated with a plurality of battery cells such as in the example of FIG. 4. In FIG. 6, two elementary series-connected cells 301₁ and 301₂ and one heating element 403₁ connected across the series association of these two cells have been shown. Heating element 403₁ comprises a Zener diode 601₁ having its anode and its cathode respectively connected to the low potential terminal of cell 301₂ and to the high potential terminal of cell 301₁. As in the example of FIG. 5, Zener diode 601₁ may be replaced with a circuit carrying out the same functions as a Zener diode.

In the case where the targeted activation threshold for the heating element is high, for example, when a same heating element is associated with a plurality of battery cells as in the example of FIGS. 4 and 6, the use of a Zener diode to form the heating element is particularly advantageous. Indeed, the knee of the response curve of a high-voltage Zener diode is particularly marked as compared with that of a low-voltage Zener diode, that is, the off-state leakage of a high-voltage Zener diode is negligible. Further, for a high activation threshold, the use of a Zener diode is less expensive than the use of a programmable circuit carrying out the same functions as a Zener diode.

More generally, in the described embodiments, the heating element may be any element equivalent to a Zener diode, that is, an element with two conduction terminals capable of clamping the voltage between its conduction terminals by dissipating heat beyond a given voltage threshold or activation voltage, where the activation voltage may be selected according to the nominal full charge voltage of the sub-assembly of cells to which the heating element is intended to be connected.

FIG. 7 is a timing diagram illustrating an example of operation of a charge management circuit of the type described in relation with FIGS. 3 to 6. More particularly, FIG. 7 shows the variation over time (t) of the voltage (U) across a battery cell during a charge phase of the battery. In this example, it is considered that a heating element equivalent to a Zener diode is connected across the cell. The case of a cell having a nominal full charge voltage Uₙₒₘ, and tolerating, without being damaged, an overcharge up to a critical voltage Uₘₐₓ greater than voltage Uₙₒₘ is here considered. The heating element associated with the cell has an activation threshold U_{z} which is, in this example, in the range from voltage Uₙₒₘ to voltage Uₘₐₓ.

At a time t0 of beginning of a battery charge phase, the cell is fully or partially discharged, and voltage U of the cell is smaller than voltage Uₙₒₘ.

At a time t1 subsequent to time t0, the voltage across the cell reaches voltage Uₙₒₘ. If the charge current is not interrupted, the cell keeps on charging and the voltage thereacross becomes greater than voltage Uₙₒₘ.

At a time t2 subsequent to time t1, the voltage across the cell reaches activation threshold U_{z} of the heating element connected to the cell. At this time, current starts flowing through the heating element. The charge current is then distributed between the cell and the heating element. The cell thus keeps on charging and the voltage thereacross keeps on increasing beyond threshold U_{z}, which causes an increase of the current flowing through the heating element. Under the effect of the current that it conducts, the heating element generates heat.

At a time t3 subsequent to time t2, the heating element reaches a temperature level causing a stopping of the charge, that is, an interruption of the charge current. At that time, the voltage across the cell is at a value U_{end} in the range from voltage U_{z} and voltage Uₘₐₓ.

After time t3, the cell discharges into the heating element and the voltage thereacross decreases. At a time t4 subsequent to time t3, the voltage across the cell settles at value U_{z}.

During the overcharge phase between times t2 and t3, the other battery cells keep on discharging. If, at time t3, all the battery cells have been taken to the activation threshold of their respective heating elements, then, after time t3, all the cells partially discharge into their respective heating elements, and then stabilize at threshold U_{z}. The battery cells are then balanced. If, however, at time t3, certain battery cells have not reached threshold U_{z}, then, after time t3, the discharge current of the cells having exceeded level U_{z} keeps on (between times t3 and t4) charging the less charged cells. This contributes to at least partially balancing the battery cells.

It should be noted that, as previously mentioned, in the case of cells capable of withstanding no overcharge beyond their nominal full charge voltage (Uₙₒₘ=Uₘₐₓ), activation threshold U_{z} may be selected to be lower than the nominal full charge voltage, and the charge management circuit may be configured so that voltage U_{end} of the cell at time t3 is smaller than voltage Uₙₒₘ.

The described embodiments are not limited to the examples of heating elements described in relation with FIGS. 5 and 6. It will be within the abilities of those skilled in the art to provide other heating elements capable of generating heat when the voltage across the cell exceeds a threshold. For example, the heating element may comprise a voltage comparator having its output connected to a resistor capable of generating heat, the activation of the comparator output to a high state causing the powering of the resistor and thus the generation of heat.

Whatever the type of heating element used, the latter is preferably sized to generate a sufficiently high temperature rise to cause the interruption of the charge before the cell voltage reaches a critical level capable of resulting in the destruction thereof.

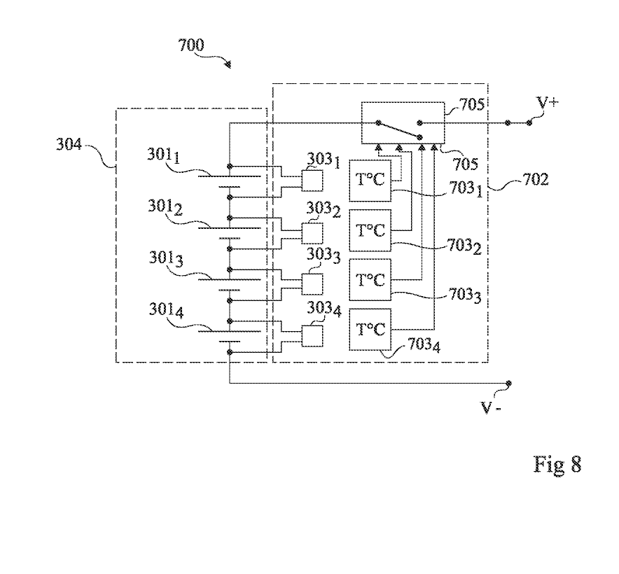

FIG. 8 is an electric diagram illustrating an example of an assembly 700 comprising battery 304 and another embodiment of a charge management circuit 702. Charge management circuit 702 comprises, as in the example of FIG. 3, in parallel with each of cells 301ᵢ, a heating element 303ᵢ configured to generate heat when the voltage thereacross exceeds an activation threshold, for example selected according to the nominal full charge voltage of the cell. Circuit 702 further comprises, in the vicinity of each of heating elements 303ᵢ, a temperature sensor 703ᵢ thermally coupled to heating element 303ᵢ. Circuit 702 further comprises a control circuit 705 configured to control the battery charge according to the temperatures measured by sensors 703ᵢ.

An advantage of the embodiment of FIG. 7 is that it enables to perform a relatively accurate balancing of the battery cells during charge phases. As an example, control circuit 705 may be configured to decrease the charge current as soon as one of temperature sensors 703ᵢ detects a temperature rise corresponding to the activation of the heating element which is associated therewith. The charge current is for example decreased so that, at the level of this cell, all the charge current starts flowing through heating element 303ᵢ, which amounts to interrupting the charge of this cell. As an example, if heating element 303ᵢ is a Zener diode, the charge current is decreased below the current threshold that the Zener diode can absorb without for the voltage thereacross to increase. A decreased charge current can then be maintained until all sensors 703ᵢ detect a temperature rise, that is, until all cells are charged and the battery is balanced. The charge current can then be interrupted by circuit 705. The battery is then balanced since all its cells have been taken to the same voltage level, that is, the activation voltage of the heating elements of circuit 702.

Specific embodiments of the present invention have been described. Various alterations, modifications, and improvements will readily occur to those skilled in the art.

In particular, the invention is not limited to the above-described examples where the elementary battery cells are series-connected. It will be within the abilities of those skilled in the art to adapt the described embodiments and obtain the desired operation in the case where the cells are connected in parallel or according to a topology combining series associations and parallel associations.

Further, the invention is not limited to the above-described examples where the batteries comprise four elementary cells. It will be within the abilities of those skilled in the art to obtain the desired operation whatever the number of elementary cells.

Further, the invention is not limited to the described examples of modes of control of the battery charge current according to the temperature measured by the temperature sensor(s) of the charge management circuit. It will be within the abilities of those skilled in the art to provide other charge current control modes providing the desired results of battery protection against damage due to overcharges, and/or of cell balancing during charge phases.

1. A circuit for managing the recharge of a battery comprising several elementary cells connected in series, the circuit comprising:
a plurality of heating elements, each heating element being a Zener diode or an element equivalent to a Zener diode and being capable of clamping the voltage thereacross by dissipating the heat beyond an activation voltage, the different heating elements being intended to be connected across different sub-assemblies of one or a plurality of cells of the battery, and the activation voltage of each heating element being selected according to the nominal full charge voltage of the sub-assembly of cells to which it is intended to be connected;
at least one temperature sensor capable of detecting an activation of one or a plurality of said heating elements; and
a control circuit capable of controlling the charge current of the battery according to detections of activations of heating elements by the temperature sensor.

2. (canceled)

3. The circuit of claim 1, wherein the activation voltage of each heating element is greater than or equal to the nominal full charge voltage of the sub-assembly of cells to which it is intended to be connected.

4. The circuit of claim 1, wherein the activation voltage of each heating element is smaller than the nominal full charge voltage of the sub-assembly of cells to which it is intended to be connected.

5. The circuit (302; 402; 702) of claim 1, wherein each heating element comprises a Zener diode.

6. The circuit of claim 1, wherein each heating element comprises an integrated clamping circuit having a programmable activation voltage.

7. The circuit of claim 1, wherein each sub-assembly comprises a single cell.

8. The circuit of claim 1, wherein each sub-assembly comprises at least two cells.

9. The circuit of claim 1, comprising a plurality of temperature sensors, the different temperature sensors being thermally coupled with different heating elements.

10. The circuit of claim 1, wherein the control circuit is configured to modify the charge current when the activation of a heating element is detected.

11. The circuit of claim 10, wherein said modification comprises decreasing the charge current without totally interrupting it.

12. The circuit of claim 10, wherein said modification comprises interrupting the charge current.

13. The circuit of claim 9, wherein the control circuit is configured to interrupt the charge current when each of said temperature sensors detects an activation of a heating element.

14. An assembly comprising a battery of elementary cells connected in series and the charge management circuit of claim 1.
